(19) United States
(12) Patent Application Publication
(10) Pub. No.: US 2021/0310282 A1
(43) Pub. Date: Oct. 7, 2021

(54) Shower Handle Lock

(71) Applicant: Pamela Jackson, DeRidder, LA (US)

(72) Inventor: Pamela Jackson, DeRidder, LA (US)

(21) Appl. No.: 16/841,639

(22) Filed: Apr. 6, 2020

(51) Int. Cl. E05B 65/48

(52) U.S. Cl. CPC E05B 65/48; E05B 2009/008; E05Y 2900/114

(57) ABSTRACT

An apparatus for denying access to the shower activation handle, and therefore the shower, by engulfing the shower activation handle in a locked, clam shell like cavity.

### BACKGROUND OF THE INVENTION

The present invention relates to a lock for fastening to the handle or knob that activates a shower. There are many instances where it is necessary or desirable for a shower's use to be restricted. One such use is when a shower is made available to the elderly, the mentally impaired, or the developmentally delayed. It is extremely important, for instance, that the temperature of the water be properly adjusted before the shower is activated. In addition, there are situations in which the regular shower user may not be capable of deciding when a shower should be taken. Sometimes a person may be fully capable of living for periods of time unsupervised except for the overuse or misuse of the shower. As society seeks for ways to enhance the quality of life by allowing individuals to stay in their own homes, certain adjustments must be made. One of these is the restriction of the shower's use. The invention as described herein accomplishes that goal.

### DESCRIPTION OF THE PRIOR ART

Several crude devices have been designed in an attempt to solve the access problem, however they all lack the simplicity of design and effectiveness of the present invention.

### BRIEF DESCRIPTION OF THE DRAWINGS

FIG. 1 is a back elevation view of the shower handle lock.

FIG. 2 is a front elevation view of the shower handle lock in open position.

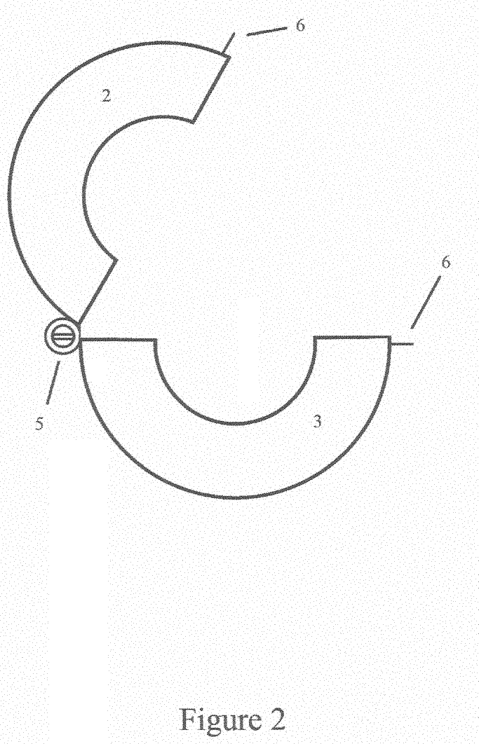

FIG. 3 is a side elevation cutaway view of the shower handle lock containing a shower activation handle.

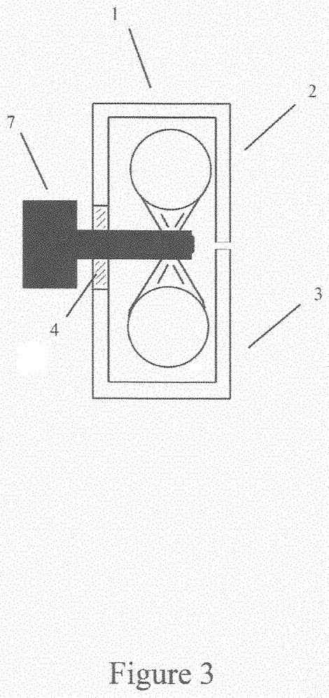

FIG. 4 is a rear elevation view of a shower lock built to deny access to the water supply knobs as well as the shower activator handle.

### DETAILED DESCRIPTION

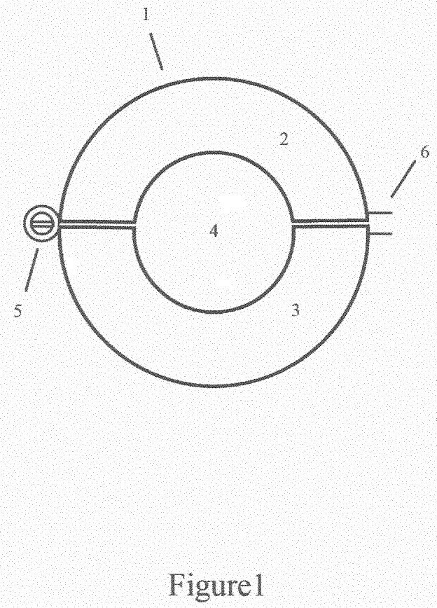

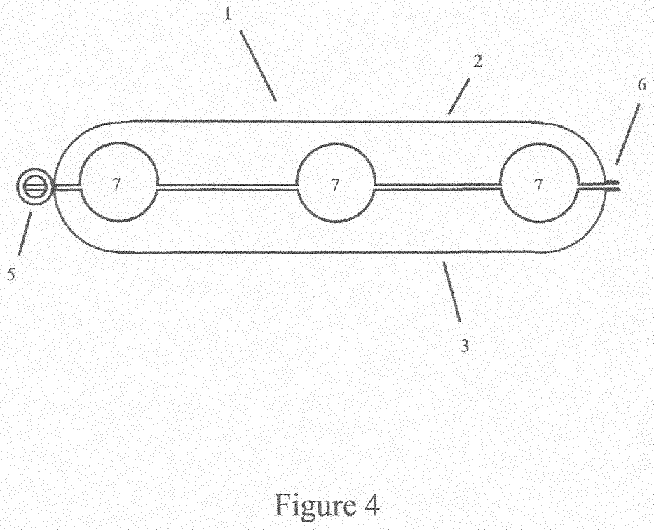

Referring to the drawings and more specifically to FIG. 1, it can be seen that the shower handle lock comprises a circular, clam shell like housing 1 forming a cavity which engulfs and therefore denies access to the shower activator handle. It is not necessary that the device be round. It could be square for example. The device could also be elongated so as to lock both the shower activator and the water supply knobs as in FIG. 4. Housing 1 is divided laterally into upper housing half 2 and lower housing half 3. A hole 4 is present at the central point where upper half 2 and lower half 3 come together while closed. The hole is formed by a suitably located semicircular cutout in upper half 3 and lower half 3. Hinge 5 makes it possible to open clam shell like housing 1. When clam shell housing 1 is opened the shower activation handle may be inserted into the housing. When it is closed, the shower activation handle is trapped within clam shell like housing 1. Latch 6 is then latched so as to deny opening of the clam shell like housing, denying access to the shower activation handle. Latch 6 may be any of several types of latches.

Referring specifically to FIG. 4, it can be seen that another version of the shower handle lock denies access also to the hot and cold water faucet handles. In this version, the clam shell like device is elongated and has three holes 7. The center of the three holes 7 accommodates the shower activator handle, while the other two holes accommodate and deny access to the hot and cold water handles.

I claim:

1. an apparatus for preventing unauthorized use of a shower comprising, a clam shell like device, said device further comprising an upper half and a lower half, said device further comprising a hinge, said hinge connecting said upper half to said lower half, said device further comprising a latch, said latch being affixed to said device opposite to said hinge, said upper and lower halves further comprising a semicircular cutout, said cutout forming a passage hole when said device is closed, said hole being concentric to said device.

2. an apparatus as described in claim 1, wherein said clam shell like device is round.

3. an apparatus as described in claim 1, wherein said clam shell like device is elongated, said clam shell like device further comprising three passage holes.

4. an apparatus as described in claim, wherein said latch is a hasp.

5. an apparatus as described in claim 1, wherein said latch is a keyed latch.
